(19) United States
(12) Patent Application Publication
(10) Pub. No.: US 2015/0106434 A1
(43) Pub. Date: Apr. 16, 2015

(54) COMPOSITONS, METHODS AND SYSTEMS FOR RETRIEVAL OF HARVEST DATA

(71) Applicants: Larry Fiene, Prairie du Sac, WI (US); Mitchell Fiene, Prairie du Sac, WI (US); Zach Fiene, Prairie du Sac, WI (US); Sawyer Kennedy, Mazomanie, WI (US)

(72) Inventors: Larry Fiene, Prairie du Sac, WI (US); Mitchell Fiene, Prairie du Sac, WI (US); Zach Fiene, Prairie du Sac, WI (US); Sawyer Kennedy, Mazomanie, WI (US)

(21) Appl. No.: 14/510,992

(22) Filed: Oct. 9, 2014

Related U.S. Application Data
(60) Provisional application No. 61/889,191, filed on Oct. 10, 2013.

(51) Int. Cl. H04L 29/06; G06Q 50/02; G06Q 10/06

(52) U.S. Cl. CPC H04L 67/42; H04L 63/08; G06Q 10/063; G06Q 50/02
USPC 709/203

(57) ABSTRACT

The present invention relates to cloud-enabled devices configured to collect and transfer data to the cloud via automated processes embodied in a dedicated device. In particular, the present invention relates to retrieval and remote analysis of harvest data of a diversity of crops including, for example, determination of corn, soybean and wheat harvest yields.

### FIELD OF THE INVENTION

The present invention relates to cloud-enabled devices configured to collect and transfer data to the cloud via automated processes embodied in a dedicated device. In particular embodiments, the present invention relates to retrieval and remote analysis of soil, planting, application harvest, and other layered data of a diversity of crops including, for example, determination of corn, soybean and wheat harvest yields.

### BACKGROUND OF THE INVENTION

Millions of acres of farmland are harvested annually using machinery outfitted with the global position system (GPS) sensing, and the capacity to collect and formulate yield data as the crop is taken up that is then translated into yield maps. A field's yield may be defined as the amount of crop harvested per unit of land in the field. When measuring corn yield, for example, “220 bushels/acre” indicates that 220 bushels of corn on average was harvested from each acre of farmland from the field in question. Yield data is significant to a diversity of stakeholders in agriculture including the farmer, the seed dealer, the chemical and service supplier, the investor, regulatory agencies, commodity traders and the like in order to measure return on investment. The yield a farmer produces in a given year determines the amount of revenue the farmer will collect for the year. In turn, service providers to farmers are responsible for consultation and advice to farmers in order to increase yields year to year. Accordingly, yield data captured during harvest serves as business intelligence for those in agriculture.

Contemporary yield data is expressed through GPS maps that depict geo-referenced yield information across a particular field. At present, yield data and maps are manually transferred to users via flash-drive. Users may then deliver the data to further downstream parties. Thus, farmers and service providers are distracted and inconvenienced during and after harvest by data transfers using physical media that may be misused, damaged, or lost. For example, at a large cooperative in Wisconsin it was noted that only 5% of the yield maps they sought each year are actually collected because farmers do not have the time needed to download data captured by their combines and deliver it to their cooperative. Lack of timely information can lead to, for example, over-application of fertilizer. Fertilizer is often applied using geo-referenced shaped files that correspond to the amount of nutrients needed by a specific location in the field of application. The system, known as variable rate technology or VRT, depends on the yield data furnished to the applicator prior to the application. Crops remove a soil nutrient per unit of grain, fruit, or vegetable produced. For instance a 200 bushel corn crop removes about 160 lbs. of nitrogen from the soil. If a farmer estimates his yield at 200 bushels, he will spread 160 lbs. of nitrogen across his acres, but if he only harvests 100 bushels (i.e., as may happen during a drought, hail storm, or other weather or pest phenomenon), he or she would only remove 80 lbs. of nitrogen. A combine yield monitor provides data as a geo-referenced map on many combines, but if the data remains in the combine monitor it cannot be used by the fertilizer supplier to apply a prescription fertilizer application that provides the correct removal rate in a given area of a field. The lack of information may lead to over application.

Embodiments of the present invention automate and eliminate the lag time between harvest and data collection. Using conventional technology, it is often necessary to assign cooperative employees to collect yield data during harvest. However, employees struggle to collect the data because stopping their combines for any reason, including letting agents download information from their machine to take back to the office, costs farmers money. A running combine generates about $50,000 of revenue an hour in a corn field. Combines cost about $400,000 each, so shutting one down for an hour during peak harvest is something many growers will not contemplate. Even though a supplier spends money to employ people to obtain the data, growers are reluctant to interrupt harvest long enough to have the data captured. Retailers, agricultural cooperatives, custom farming operations and grain facilities, among others, experience unresolved challenges with transfer of yield data arising from manual processes required in conventional methods. Clearly, improved compositions, methods and systems for collection, archiving and analysis of crop yield data are needed.

### DESCRIPTION OF THE DRAWINGS

FIG. 1. shows a block diagram comprising a program flowchart of an embodiment of the present invention.

FIG. 2. shows an NDVI field image/map.

FIG. 3. shows an example of the NDVI formula.

FIG. 4. shows an exemplary application of an embodiment of the present invention.

FIG. 5. shows a block diagram comprising a user flowchart of an embodiment of the present invention.

FIG. 6. shows an exemplary image of a composition of an embodiment of the present invention.

FIG. 7. shows an exemplary image of a composition of an embodiment of the present invention.

FIG. 8. shows a corn yield map constructed using an embodiment of the present invention.

FIG. 9. shows a corn yield map constructed using an embodiment of the present invention.

FIG. 10. shows a soybean yield map constructed using an embodiment of the present invention.

FIG. 11. shows a schematic representation of an embodiments of the present invention.

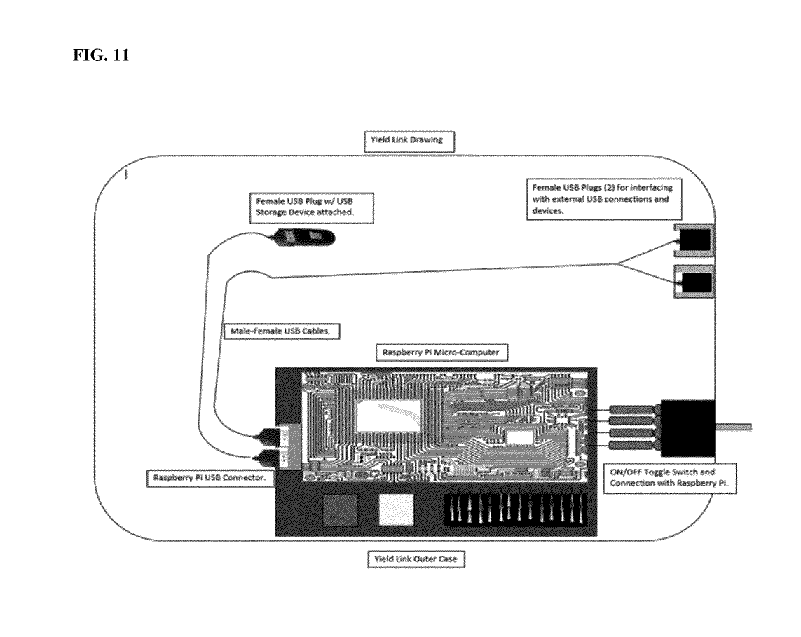

FIG. 12. shows a three dimensional rendering of an exemplary embodiment of the present invention.

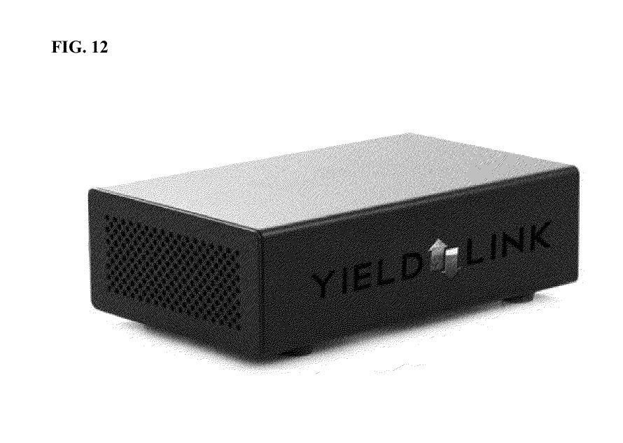

### SUMMARY OF THE INVENTION

The present invention relates to cloud-enabled devices configured to collect and transfer data to the cloud via automated processes embodied in a dedicated device. In particular, the present invention relates to retrieval and remote analysis of soil, planting, application, harvest and other layered data of a diversity of crops including, for example, determination of corn, soybean and wheat harvest yields.

In some embodiments, the present invention replaces in-person, post hoc collection of yield data with automated, real-time compositions, methods and systems configured to directly, automatically, and passively retrieve yield data from, for example, a combine, and automatically transfer the data to cloud storage at an online storage facility where it may be viewed by approved users with a secure username and password on demand. Thus, farmers, seed dealers, equipment dealers, agricultural co-operatives, investors and traders, and other agricultural stakeholders may have access to the data without interruption of work flow, and without the requirement for, and multiple shortcomings of, physical storage media. Because data is not archived on certain embodiments of compositions of the present invention, loss or destruction of the device does not place previously acquired data in jeopardy.

In some embodiments, the harvest data acquisition system of the present invention comprises a yield monitor in electronic communication with a harvest data acquisition device; a harvest data acquisition device comprising a universal series bus (USB), a USB compatible cable, a power adapter and AC/DC converter, a tablet computing device comprising a processor, micro SD card and 4G connector, a microcomputer unit operating system; a component configured for Wi-Fi connectivity, harvest data acquisition software on computer readable media configured for auto-booting of said device, file recognition, retrieval and transfer to cloud-based storage facilities, and access by credentialed users, an enclosure, and a dashboard visual display for display of agricultural, service provider, or economic data acquired by said harvest data acquisition system.

In some embodiments, the present invention provides a “plug and play” cloud-upload automation device. In some embodiments, such a device is utilized with a data capturing system or sensor (e.g., for agricultural, industrial, medical, commercial, personal or other purposes). In some embodiments, the cloud-upload automation device allows collected data to be automatically (e.g., in real-time) uploaded to the cloud upon collection without additional steps by a user.

In some embodiments, the components, devices, systems, and methods described herein, as well as portions of elements thereof, may find use in any application or field (e.g., agricultural, industrial, medical, commercial, personal or other purposes), are not limited to the applications described herein, and may find use in combination with existing components, devices, systems, and methods know to those in the applicable fields.

### DEFINITIONS

To facilitate an understanding of the present invention, a number of terms and phrases are defined below:

The term “user” refers to a person using the compositions, methods or systems of the present invention.

The term “system” is used to refer to a data management system (e.g., online). The term “database” is used to refer to a data structure for storing information for use by the system.

As used herein, the terms “processor” and “central processing unit” or “CPU” are used interchangeably and refer to a device that is able to read a program from a computer memory (e.g., read only memory (ROM) or other computer memory) and perform a set of steps according to the program.

As used herein, the term “Internet” refers to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc.). The term is also intended to encompass non-public networks such as private (e.g., corporate) Intranets.

As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

As used herein, the term “web site” refers to a computer system that serves informational content over a network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “in electronic communication” refers to electrical devices (e.g., computers, processors, etc.) that are configured to communicate with one another through direct or indirect signaling. For example, a conference bridge that is connected to a processor through a cable or wire, such that information can pass between the conference bridge and the processor, are in electronic communication with one another. Likewise, a computer configured to transmit (e.g., through cables, wires, infrared signals, telephone lines, etc.) information to another computer or device, is in electronic communication with the other computer or device.

As used herein, the term “transmitting” refers to the movement of information (e.g., data) from one location to another (e.g., from one device to another) using any suitable means. As used herein, the term “intermediary service provider” refers to an agent providing a forum for users to interact with each other (e.g., identify each other, retrieve and analyze data, etc.). In some embodiments, the intermediary service provider is a hosted electronic environment located on the Internet or World Wide Web.

As used herein, the term “client-server” refers to a model of interaction in a distributed system in which a program at one site sends a request to a program at another site and waits for a response. The requesting program is called the “client,” and the program which responds to the request is called the “server.” In the context of the World Wide Web, the client is a “Web browser” (or simply “browser”) which runs on a computer of a user or another computer that sends HTML requests to the “server” (e.g., Web Services); the program which responds to browser requests by serving Web pages is commonly referred to as a “Web server.”

As used herein, the term “hosted electronic environment” refers to an electronic communication network accessible by computer for transferring information. One example includes, but is not limited to, a web site located on the World Wide Web.

As used herein, the term “Wi-Fi hotspot” and “Wi-Fi connectivity” refers to the use of Wi-Fi provided by a device located in close proximity to a Wi-Fi compatible device for the purpose of transmitting and/or receiving information.

As used herein, the term “computer readable media” refers to data that can be understood and/or read by a computer. Correct file formats for example are needed by some programs to understand what the data is saying and how it should be used.

As used herein, the term “UAVs” refers to unmanned aerial vehicles. Other names commonly associated with this term include drones or UAS's. The term UAS refers to an Unmanned Aerial System which is a general term for UAV's and the systems required to fly them.

As used herein, the term “USB” refers to the universal serial bus, a globally recognized term in the computer community for a compatible data storage and sharing device.

As used herein, the term “Samsung Galaxy tab 2, rooted and running Android 4.0 (Ice cream sandwich)” refers to a device running, for example, a Yield Link program. Samsung, a globally recognized technology manufacturer, produces a tablet-computing device called the Galaxy Tab. The second version of this product is known as the Samsung Galaxy Tab 2. The Android (Google-Owned Operating System name, similar to Apple's iOS or Microsoft's Windows' names) 4.0 Ice Cream Sandwich operating system, is a system that houses and runs, for example, a Yield Link App. Ice Cream Sandwich is the name given to a specific Android operating system used herein.

Google provides names for new operating systems after deserts in alphabetical order based on release date. For example previous operating systems included Cupcake, Donut, Éclair, Froyo, Gingerbread, and Honeycomb. Their current operating system is the Jelly Bean operating system. Ice Cream Sandwich is an embodiment of the present invention for use with, for example, a John Deere Greenstar series of Yield Monitor. Other embodiments are adapted for other operating systems for use with other Yield Monitors. Additionally, different tablets or other computing devices may, in some embodiments, used for specific Yield Monitors. For example, a Precision Planting Yield Monitor runs on iOS thereby enabling use of an embodiment of the present invention with an iOS platform and tablet (iPad).

As used herein, the term “operating system” refers to the type of base programming used to setup a computer's central processing unit.

As used herein, the term “John Deere GreenStar system” refers to the operating system running the onboard monitors utilized by John Deere equipment. The Greenstar Yield Monitor, for example, is a computer capable of user-input and output for a variety of farming information. Data relating to planting, applicating, and harvesting may be captured by the Greenstar system, extracted and then sent to the cloud via an embodiment of the present invention.

As used herein, the term “Smart Construction Technology, Intelligent shipping technology” refers to advancements made in construction and shipping technology instruments and monitors able to calculate digging depth, GPS location, weight distribution, and the like. Similar to advancements in agriculture with equipment outfitted with GPS and sensor technology, construction and shipping are developing digitally-enabled applications. Many items of industrial construction equipment are provided with GPS guidance as well as sensors (e.g., pressure sensors) and other instruments. However, these instruments provide real time data that is isolated on the machine with the operator. External knowledge of this information cannot be obtained until after acquisition, and must be distributed via physical storage devices such as flash drives. In the shipping companies are implementing smart sensors to read weight distribution on semi-trailers, for example and ware on tires, axels, and bearings of the trailers. This data is often not viewable on a live-feed basis from anywhere with an Internet connection prior to the development of embodiments of the present invention.

As used herein, the term “Yield Link app” refers to an application running file—transferring processes of embodiments of the present invention. Additionally, the term “Yield Link_APA Auto Boot” refers to the ability, through the Yield Link app, to auto-boot or start-up automatically when plugged into a USB port. In other embodiments, a device of the present invention comprises an “on-off” switch.

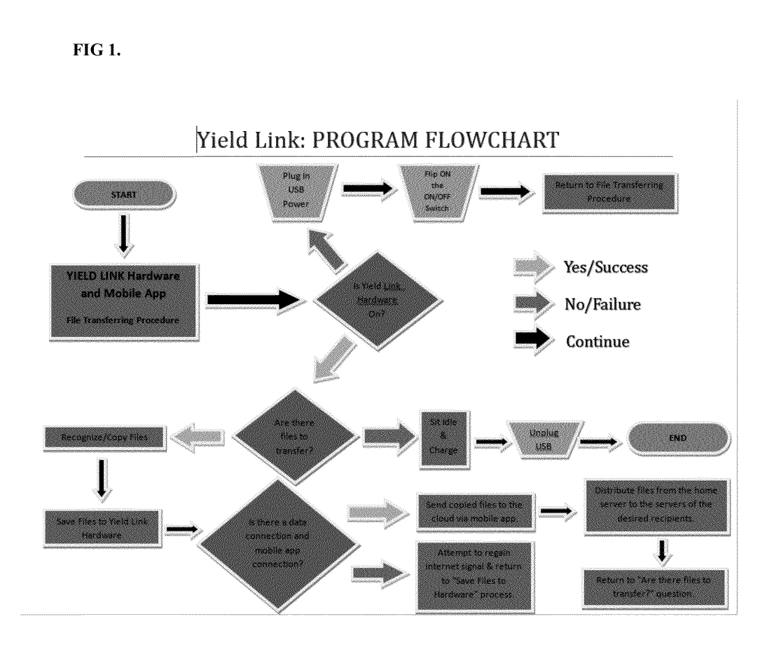

As used herein, the term “Yield Link_SCP File transfer program” refers to a file transfer application running an embodiment of the present invention. FIG. 1. shows a block diagram of an embodiment of the present invention that: 1.) recognizes there are files to be transferred on a piece of equipment/monitor; 2.) copies the files or extracts from hardcopy depending on user preferences; 3.) transfer the files to the cloud over a 3G or 4G connection provided by the tablet in some embodiments and by the users' own smart phones in other embodiments wherein data connections are provided by an outside device such as a data-connected smartphone or tablet rather than through a dedicated data connection within the Yield Link hardware system; and 4.) forwards the files to a designated server for viewing by downstream parties.

As used herein, the term “boot” refers to the action of an embodiment of the present invention starting-up. Additionally, the term “3G or 4G connection” refers to the data connection over which information/data is transferred from a hard-device (a yield monitor for example) to an online storage facility also known as the cloud.

As used herein, the term “HD imagery” refers to imagery (e.g., videos or pictures) that have a resolution of 720 pixels or greater.

As used herein, the term “NDVI imagery” refers to imagery displayed using a Normalized Difference Vegetation Index Formula or;

=NIR−(RED or VISIBLE)/NIR+(RED or VISIBLE).

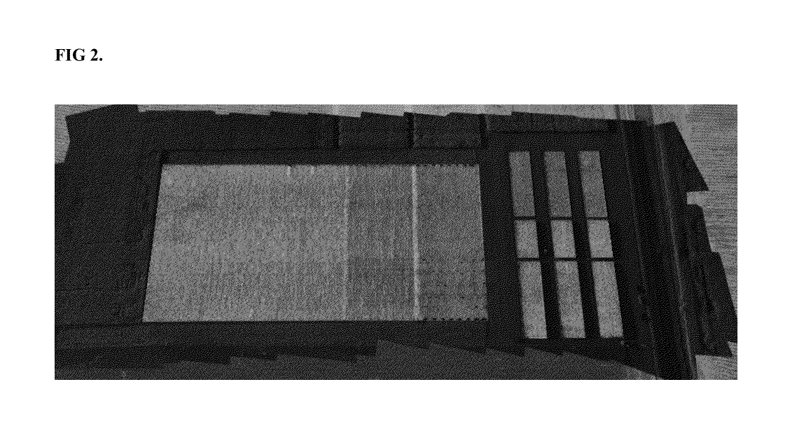

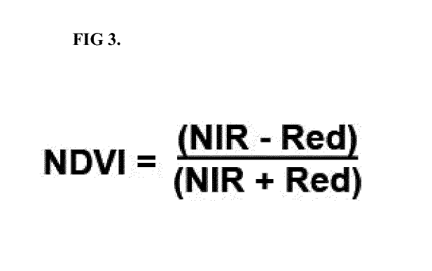

The formula provides the effectiveness of a plant in using its evolutionary strengths. Plants over time have developed the ability to reflect harmful light (e.g., near infra-red light) and absorb beneficial light (RED or VISIBLE) for photosynthesis. The NDVI formula assigns scores to plants based on the formula, and its programs provide color code for scores across a field. FIG. 2. shows an NDVI image/map. FIG. 3. shows an example of a NDVI formula. NDVI Imagery provides images that may be used by producers using advanced, precision agricultural techniques. NDVI imagery captures data invisible to the naked eyes (i.e., that is contained beyond the visible light spectrum), and provides recommendations for solutions to poor crop health before significant yield potential is lost.

As used herein, the term “business intelligence tools” refers to application software designed to retrieve, analyze and report data for business intelligence. These tools are used in corporate America to read data that has been previously stored, often, though not necessarily, in a database, data warehouse, or data mart.

As used herein, the term “dashboard” refers to a display that provides an at-a-glance view of KPIs (key performance indicators) relevant to a particular objective or business process (e.g. Planting, Spraying, or harvest data). In some embodiments, dashboards provide signs about a business's health, letting the user know something is wrong or something is right.

As used herein, the terms “agriculture data” and “agricultural data” refer to information relating to the science or practice of farming including cultivation of the soil for the growing of crops and the rearing of animals to provide food, wool, and other products. In certain embodiments, the terms “agriculture data” and “agricultural data” refer to information representing agricultural management practices including nitrogen fertilizer application, crop and livestock statistics, and agricultural land use.

As used herein, the term “cloud” refers to a model of data storage where the digital data is stored in logical pools, the physical storage spans multiple servers (and often locations), and the physical environment is typically owned and managed by a hosting company rather than by a user. The term “cloud” is often used in conjunction with the term storage because it is most basically understood as an online data storage system. cloud storage means “the storage of data online in the cloud,” wherein a company's or person's data is stored in and accessible from multiple distributed and connected resources that comprise a cloud. Generally a cloud involves physical storage media however that physical storage media (such as a server for example) is often located outside the immediate proximity of the user. The user then sends the data he or she would like to save to the cloud through a digital connection, many times over the internet. The user then has remote access to the actual physical storage locations and can retrieve their data whether they are near the storage site or distant from it, using a digital connection (e.g., the internet).

As used herein, the term “private cloud infrastructure” refers to a cloud storage system is built, owned, and/or operated by private individual(s) or group(s) for their own storage needs. Much of the cloud storage marketplace is dominated by “Hosting Companies” that have what are called server farms (which are physical locations with numerous servers used to store data). These companies host (or store) data for people and companies at these server farms and charge a storage fee; whereas, a “private cloud infrastructure” is operated by an individual or group for their own use (e.g., personal use, commercial use, etc.). A “private cloud infrastructure” may comprise a server hub with dual-way communication capabilities (e.g., it can receive data over a digital connection and store it or it can push data from itself out to an end user via a digital connection).

### DETAILED DESCRIPTION OF THE INVENTION

The present invention relates to cloud-enabled devices configured to collect and transfer data to the cloud via automated processes embodied in a dedicated device. In particular, the present invention relates to retrieval and remote analysis of soil, planting, application, micro-climate, harvest and other layered data of a diversity of crops including, for example, determination of corn, soybean and wheat harvest yields. In some embodiments, the present invention provides a plug and play device that immediately initiates data processing and transmittal to, for example, the cloud when it is turned on, thereby eliminating obligations for user-dependent operation. In certain embodiments a user may remove the device of the present invention from its packaging, connect it to its USB input port and acquire data with no further steps required.

In some embodiments, the present invention provides an integrated solution for retrieval and remote analysis of harvest data from any device able to transfer data through a wireless or cable connection. Compositions, methods and systems of the present invention may be used with any physical yield monitor including, for example, John Deere, Case IH, Precision Planting, Caterpillar, New Holland, Raven, or similar yield monitors. In some embodiments, compositions of the present invention may be used with any device with the ability to transfer data including, for example, construction equipment, automobiles, trail/game cameras, phones, tablets, computers, hard drives, mining equipment, trucking and shipping equipment, marine equipment, trains, and the like.

In some embodiments, the compositions, methods and systems of the present invention provide a Wi-Fi hotspot within the cab of a combine, or surrounding equipment in use (e.g., trail camera, backhoe, mining drill, container ship, semi-truck, etc.). In certain embodiments, the present invention provides the ability to retrieve and transmit yield data (or other data) to the cloud, and also enables Internet access within the combine (or other enabled equipment). Internet capability may then be used for a broad array of applications including further data transfer, entertainment, communication, weather updates, equipment tracking, autonomous units (such as UAV's, tractors, combines, etc.), or other positive features of Internet access.

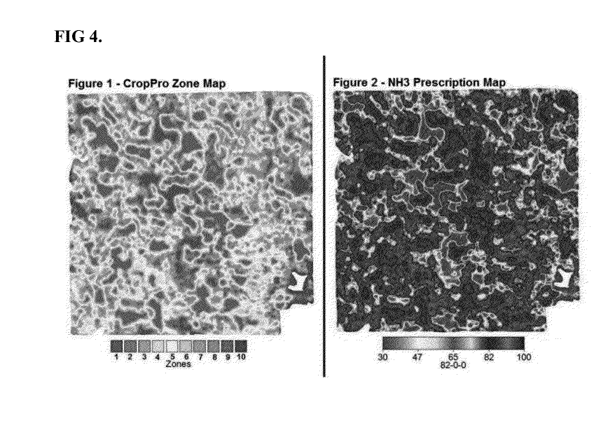

In some embodiments, the present invention comprises a Samsung Galaxy tab 2 rooted and running the Android 4.0 (Ice cream sandwich) operating system congruent with the file transferring processes capable with, for example, the John Deere GreenStar system. (FIG. 4.) In further embodiments, the present invention comprises a Raspberry Pi microcomputer, outfitted with the aforementioned file transferring program. In yet further embodiments, the present invention provides additional versions of Android, iOS, and other operating systems as well as various types and brands of tablets or computer/tablet components. Selection of operating system and hardware components are contingent on the capacity of the unit (i.e., piece of equipment/machine that sources the data) to send data. For example, an Apple-based yield monitor uses an iOS-based unit. Accordingly, the present invention provides an adaptive unit with the capacity to substitute operating systems, and to function with multiple brands of yield monitors specifically, and multiple brands of other information units (i.e., Smart Construction Technology, Intelligent shipping technology, trail cameras, etc.) as well.

In some embodiments, the present invention comprises in-line USB power adapter that enables plug and play function. In certain embodiments, upon removal of a device of the present invention from its packaging, the user may plug the device into a USB outlet on, for example, a combine and begin powering the unit and transferring files. Any power cord adapter may be used including USB, mini USB, and Apple-based power chords such as the thunder and lightning cables, or any other charging cord head. In some embodiments, the present invention comprises a battery. In certain embodiments, a battery provides energy to power a tablet computer or microcomputer that is engaged when it is connected to a USB port. In other embodiments, a device of the present invention is charged when it is connected to a USB port.

In some embodiments, the present invention provides a 10′ USB Extension cable enabling personalized use by, for example, a farmer or grower. The extension cable enables placement of the device as preferred within the cab of a combine or other workspace. The extension may be shorter or longer depending on the specific needs of the user. A cable spool or other cable retracting tool may be used to increase or decrease the cable range of the device, however a fixed cable link may be used for specific applications wherein the user does not require increased cable length. In some embodiments, the cable extension may comprise a data-transferring/power cable including, for example, a USB cable or Thunder cable from Apple. In still further embodiments, USB plugs are provided on the side of the present invention and users may plug their own USB connections into the device.

In some embodiments, the present invention comprises an 8 GB Micro SD card configured to enable storage of data from the Yield Link application that runs a file transferring process. In certain embodiments, the 8 GB Micro SD card provides storage for copied files if, for example, the user also wishes to use the present invention as a conventional flash-drive. The size of the SD card, or other data storage unit, depends on the uses preferred by users including, access to increased storage for additional files should the device of the present invention be used as a physical-location flash-drive.

In some embodiments, the present invention comprises a DC-AC Converter to power the device within the combine as it changes direct current (DC) from the unit's battery, to alternating current (AC) which is used to power the compositions, methods and systems of the present invention.

In some embodiments, the present invention comprises a plastic-based, acrylic-based, wood-based, or metallic-based enclosure for protection from dirt, moisture, vibration, dropping, wind, electronic interference, radio-frequency interference, and the like. In certain embodiments, the enclosure is permanently sealed and houses computers running programs of the present invention, applications, and Wi-Fi units that allow for cloud upload and hotspot capability. In other embodiments, users may use their phone's data connection to transfer data instead of internal Wi-Fi units. In this embodiment, users would utilize the Yield Link Mobile application. In further embodiments, the enclosure may be latch-shut to allow for access to the inner units should users prefer access to the components inside. In certain embodiments, the enclosure comprises features according to the specific uses, for example, color, texture, protuberances for anchoring, and the like. In rugged environments such as farming, mining, shipping, or construction, a ruggedized enclosure is contemplated. In further embodiments, the present invention provides a screen display within the enclosure behind, for example, a glass protection area.

In some embodiments, the present invention comprises software, for example, Android 4.0 (Ice Cream Sandwich) software compatible with yield monitors. In certain embodiments, the present invention may be adapted to perform with a diversity of machinery and equipment. As noted above, different collateral equipment (e.g., Apple equipment) may determine distinct operating systems and the diverse tablet computers and microcomputers running inside the present invention may be running their own operating systems separate from Android or iOS. Accordingly, the present invention provides compositions and methods with the capacity to change operating systems as preferred.

In some embodiments, the present invention comprises a Yield Link_APA Auto Boot that, when connected to a USB port provides a plug and go feature. When a user plugs the USB link into the USB drive, in certain embodiments, the present invention boots automatically and begins executing its file transferring processes.

In some embodiments, the present invention comprises a Yield Link_SCP File transfer program that enables file transfer of yield map data (or other data) from the combine (or other equipment or machinery) to the cloud. The program operates via recognition of transfer files, retrieval of files from relevant hardware, and transfer of files to a server over a data connection.

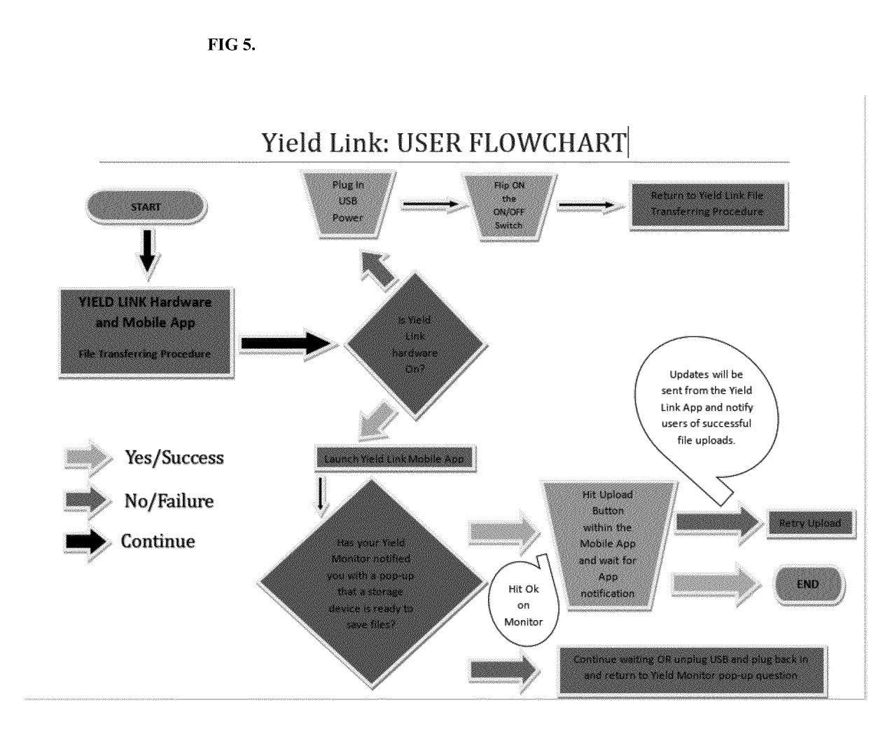

In some embodiments, the compositions, methods and systems of the present invention provide a non-intensive, user-friendly experience. (FIG. 5.) With, for example, a USB (or other cable link) connection and integrated charging cable, devices of the present invention may be operated in a plug in-and-go mode. In certain embodiments, when the device is powered it immediately begins executing its preprogrammed processes. Files stored, for example, on combine media may instantly be accessed from the machine (or copied and then accessed from the machine), and transferred to an online cloud storage facility where it may be accessed at a later time. In certain embodiments, compositions of the present invention do not comprise buttons, keys or tabs, and the hardware and software are contained within a permanently sealed plastic, acrylic, wood, metallic, etc., case. Once the device is plugged into the power outlet and USB port, it automatically boots up and begins transferring files automatically. A user must only click “ok” on their combine monitor to enable access to the devices of certain embodiments of the present invention.

In some embodiments, the present invention provides a mobile-based platform for the control of the invention. Power ON/OFF, data transfers, and the like may be monitored and controlled from users' mobile and data-enabled devices using the Yield Link mobile app, developed for Android and iOS, or run on microcomputers and other operating systems (e.g. Tizen from Samsung, a competing operating system to Android and iOS).

Conventional technology for constructing and archiving yield maps requires inconvenient, costly, and error-prone manual file transfer to distribute data to end-users. In some embodiments, the present invention provides automatic data transfer of crop yield data to suppliers and other users without distraction, costs and disruption of the harvest, and without physical transfer of storage media. Because embodiments of the present invention provide a Wi-Fi hotspot, a farmer or grower may compare previous years' yield results in real time as he or she combines this year's fields.

In some embodiments, an advantage of cloud-based data storage is enhanced protection of the data. In some embodiments, yield data acquired and archived with compositions, methods and systems or the present invention may be stored on a tablet, multiple servers, the cloud, and user personal computers, with options that can be adjusted according to the desires of the end user. A benefit of multiple passive back-up media is to provide security in keeping with the crucial nature of the data. For example, loss of data in a catastrophic situation that may ruin a user's monitor, or a device of the present invention, (e.g., a combine fire) is avoided with the cloudstorage. With cloud storage, agricultural and harvest information, for example, farm production history or data captured by a diversity of other monitors and systems, may be archived indefinitely on the internet, and accessed as desired even if the original storage unit is destroyed or lost.

Because farmers and growers may be harvesting in remote locations, it may be very difficult to distribute vital information needed to show their consultants in order to manage and improve their crops. In certain embodiments of the present invention, executing vital data management processes is not only enabled automatically, but it is also possible remotely using a 4G connection. In addition, because the present invention provides a Wi-Fi hotspot, a farmer may be similarly connected to the World Wide Web in the field as at home or the office. Because it often isn't possible to provide hardwired internet access across wide tracks of cropland commonly found in farming, Wi-Fi or data connectivity is preferred for data transfers associated with agriculture. Using 4G networks (and other networks) with a fully integrated Wi-Fi jetpack capable of emitting Wi-Fi throughout the entire combine or other machinery, embodiments of the present invention may serve as a simultaneous data transferring units for multiple streams of data. For example, embodiments of the present invention may be linked to UAV's or ground sensors collecting, for example, HD imagery, multi-spectral imagery, soil information, weather information, equipment information, irrigation information, drainage information, yield information, plant health/nutrient information, plant population information, animal population information, stockpile information, insect pressure information, microclimate information, and the like. At present, there is no efficient or real-time method to transfer this data other than in embodiments of the present invention comprising Wi-Fi or data connectivity. With Wi-Fi data connection provided by embodiments of the present invention, data may instantly transmitted to the cloud either during UAV flight (if added as a payload onboard), or immediately after flight when devices of the present invention may be connected to a UAV. Because farming operations often take place in rural locations lacking Wi-Fi access, data transfers/processes are severely limited. Using conventional technology, if farmers wish to have their data analyzed by their agricultural partners, they must first collect and store the data on physical media e.g., a physical flash drive, and then deliver the physical media or a print copy to their consultant, thereby consuming time, cost and lost opportunity. In certain embodiments, the present invention provides connectivity for UAV live data transfer to, for example, an agronomist interested in aggregating the information and making recommendations to farmers. In further embodiments, Wi-Fi connectivity provides remote UAV operation via cloud-computing controlled fully-autonomous systems.

The compositions, methods and systems of a cloud-enabled user device configured to both collect data and transfer it to the cloud via automated processes in a dedicated device described herein find use in a variety of applications. Any embodiment in which data can be retrieved via export, download, or the like, from a device and transferred to another device through any data-cable or wireless data medium, is contemplated. In some embodiments, the present invention provides a data transfer point in which stored data may be extracted from a hard-drive or server and transferred to another hard-drive or server in a different location over a wireless data medium. The process of transferring data over a wireless network to a cloud-based storage facility is achieved through automatic processes configured into hardware of the present invention using a custom software application downloadable to the present invention's hardware. In further embodiments, the present invention provides a cloud-enabled flash drive, with expanded storage space, and automated processes to transfer files from a physical location (e.g., computer, piece of equipment, flash drive, yield monitor, etc.) to an online storage facility. In some embodiments, compositions, methods and systems of the present invention provide a “cloud-enabled flash drive” with unconstrained storage arising from data transfer directly to the cloud rather than to a physical flash drive. A benefit of cloud storage is that the data can then be accessed anywhere with an internet connection without loss of information from misused, damaged, or lost flash drive devices. Instead, saved data may be backed-up in a secure location that is not connected to a physical piece of equipment.

In some embodiments, a device of the present invention is configured for connection to a phone and/or internet or to the World Wide Web. In further embodiments, the device comprises hardware and software privacy protections including encryption, and cloud-based protections. In certain embodiments, the device is shielded from tracking. In some embodiments, the device is powered solely by external equipment or batteries. In further embodiments the device is powered directly by solar, wind, heat, and/or other energy sources. In particular embodiments, the device is shielded from external radio-frequency (RF) interference, and is shielded to not emit RF signals. In other embodiments, the device uses RF frequencies, Bluetooth, Wi-Fi, or other communication media to communicate with ground sensors and various other distant sensors located away from the present invention. In certain embodiments, communication with ground sensors is relayed from a UAV to the present invention over a 900 MHz radio frequency band.

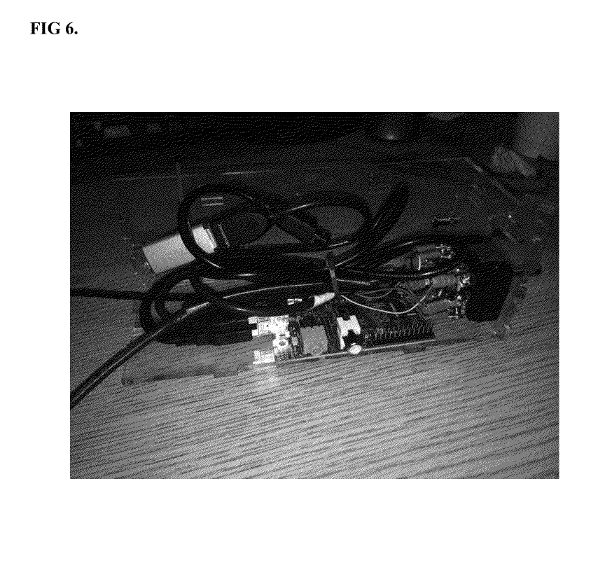

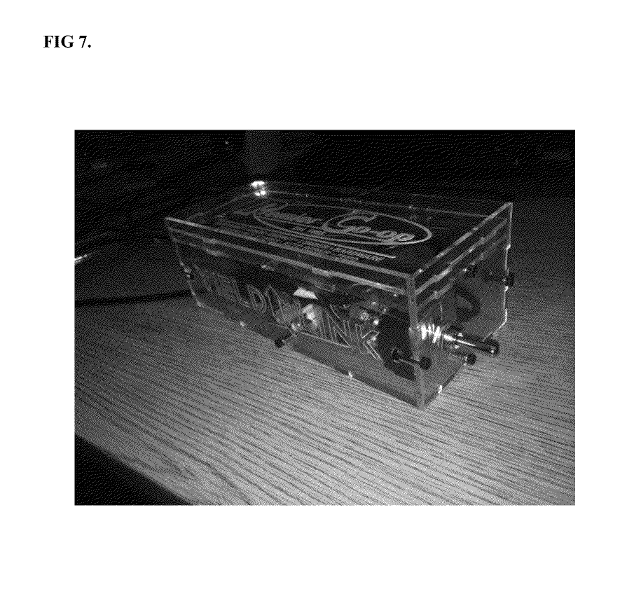

Construction of the device from any suitable material is contemplated including aluminum, titanium, plastic, metallic and non-metallic composites, acrylic, polycarbonate, nylon, glass, magnetic, conducting, or non-magnetic, non-conducting materials, and the like. (FIG. 6., FIG. 7.) In some embodiments, the device comprises a flip cover, a slip cover, a transparent cover, and the like. In other embodiments, a device of the present invention is provided with a hardened case. In some embodiments compositions of the present invention provide portable devices configured to perform multiple tasks. In some embodiments, the devices comprise a keyboard or visual scrolling features. In some embodiments, the devices comprise a display screen to depict data or images. The screen may be illuminated with a single or multiple lights of different frequencies. In some embodiments, the devices support externally loaded memory gathering devices including, for example, a chip, a thumb, a CD, a DVD, or other computer readable media. In some embodiments, the devices are shielded from internet or external sources of data and energy. In some embodiments, the devices are enclosed in a Faraday cage or enclosure. In some embodiments, the devices are configured to capture and record electronic and/or digital data including, for example, digital audio, visual, or other data. In some embodiments, the devices are protected in hardware and software from hacking, tracking, or compromise by electronic external devices.

In some embodiments, the compositions, methods and systems of the present invention provide a dashboard display comprising information addressing crop, geo-location, details of farming practices employed (e.g., planting, spraying, harvesting, and the like) and adapter status of the famers and growers. In some embodiments, the homepage of the dashboard comprises a clickable map of the world. In further embodiments, a drop down box above the map enables users to select a crop they wish to examine for planting, yield, or spay data. Once the type of data a user wishes to examine is selected, the user is able to view aggregated averages from around the globe. Specific data is available by navigation of the map to country, state, or county and township levels of resolution, together with detailed information including, for example, hybrid varieties planted and their comparative yields, chemical usage, equipment brand, preferred co-operatives, chemicals, seed, the equipment and the like to include identification of the most successful farmers and growers. In some embodiments, farmers and growers are offered provisions to assure the confidentiality of their data, and preferences for distribution of data.

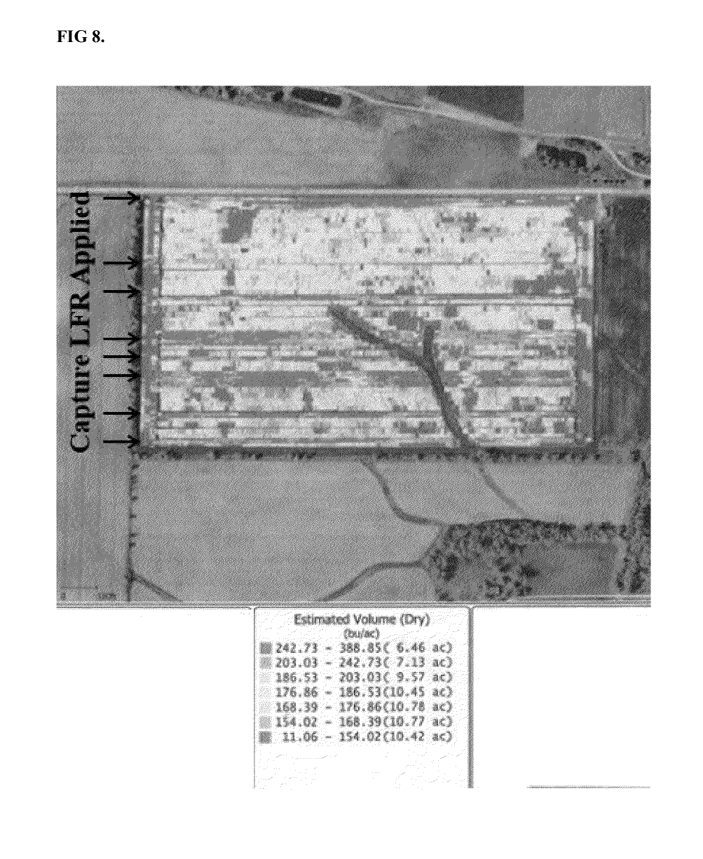

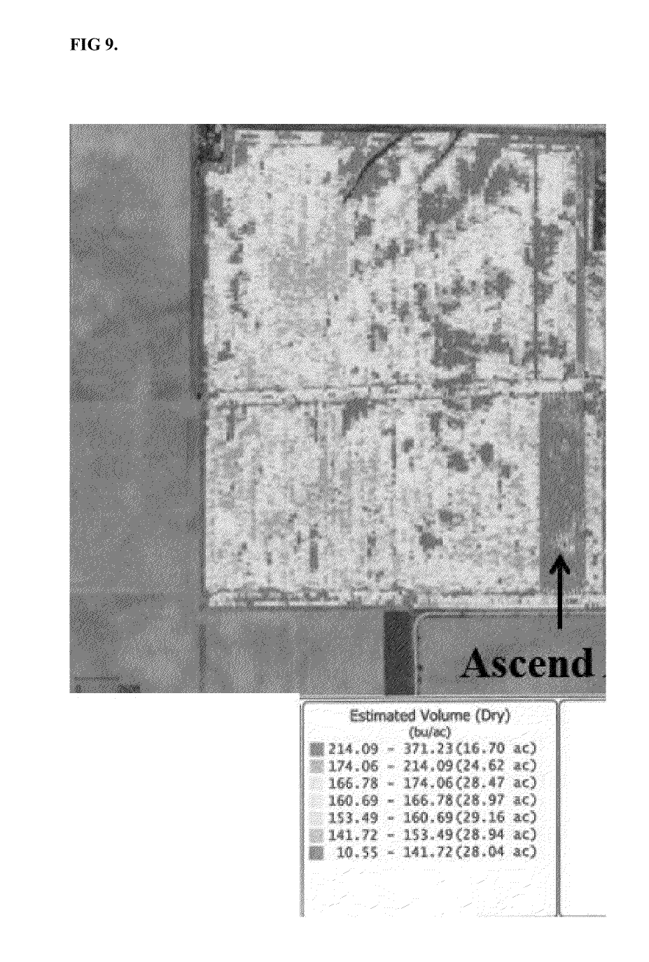

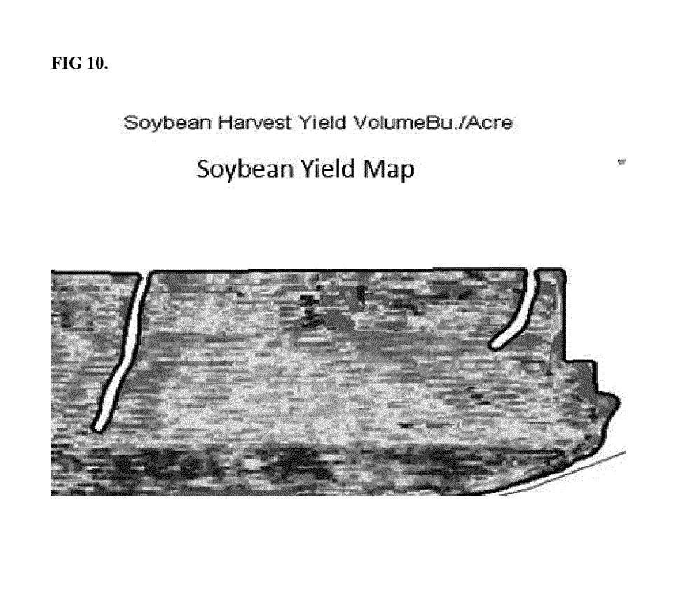

In some embodiments of the present invention, crop yields are captured and geo-referenced to provide year-to-year yield maps (FIG. 8., FIG. 9., FIG. 10.) coupled with a growing history as yield data builds over time. In some embodiments, the present invention provides multiple dashboards for different applications. For example, a farming dashboard may be individualized to each farm that aggregates information across their farm including, for example, data from monitors in the combine, planting data from planters, spray data from sprayers, and information from UAV's including HD imagery, Multispectral imagery, Yield Estimates, soil information, and the like. The dashboard serves as the business intelligence center for the farm and provides growers with detailed information about past years, current status, and the potential for the future based on extrapolated variables. In some embodiments, the present invention provides a service provider dashboard that allows a service provider to measure their product's success or failure on a certain farmer's field, and how their products faired across their customer-base, In other embodiments, the present invention provides an agribusiness dashboard with a live feed of harvest data to businesses who sell products to farmers or trade commodity futures. If a product (e.g., seed or chemical) fails to perform across a customer-base, a different recommendation may be made in the next year with better results.

In some embodiments, the present invention provides a data streaming connection in the cab of, for example, a combine or other machinery. At present, combines may be isolated vehicles with little or no communication capacity with the external world over a data connection. Accordingly, only limited information (e.g., combine operational information including hours on the machine, interval since last oil, oil level, and the like) may be forwarded to a manufacturer or other interested party. Currently, information from, for example, an on-board yield monitor or from other instruments that capture farming data (e.g., planting information, harvest information, spraying information and the like) is not automatically transferred in real time.

A surprising property of the present invention is the capacity to integrate output of the compositions, methods and systems of the present invention with Variable Rate Technology (VRT) agricultural practices. VRT provides farming and growing operators with more efficient and environmentally compatible alternatives through use of Variable Rate Techniques comprising spray technology, planting technology and the like. Using VRT exact amount of chemical or fertilizer is applied or sprayed as required by a specific plant. For example, across a field not every area of the crop requires the same amount of medicine (e.g., chemicals) or plant food (e.g., fertilizer). Most modern spray equipment is able to traverse a field and adjust the amount of a given product that is being administered. Accordingly, if one region of the field requires more nitrogen, an applicator adjusts its spray volume, and administers added nitrogen to that part of the field compared to another part of the field. In regions with ample nitrogen, an applicator lessens its spray volume or turns off completely. In this fashion, smaller amounts of chemicals and fertilizers are needed because specific regions of the field are given the specific amount needed. Prior to VRT technology, an applicator would uniformly spray a uniform volume of a product on the entire field, leading to over-spraying, under-spraying, and less efficiency in given regions of the field. Such inefficiencies create avoidable economic and environmental costs. Using only the amount of chemical or fertilizer needed, the grower may become more efficient at maximizing yield potential while conserving costs of excess product applied. Growers providing custom amounts of crop products as needed eliminate over-use of chemicals. VRT may also be used to determine which seed to plant in which areas of the field based, for example, on soil type or other variable. In turn, embodiments of the present invention provide implementation of variable rate technology as directive VRT inputs, In some embodiments, systems directing the VRT output are linked to inputs arising from embodiments of the present invention to determine, for example, which and how much product to spray, and/or what seed to plant in a specific region of a field. In some embodiments, real-time, passive, operator-friendly, direct data collection and creation of geo-referenced yield maps provides growers and farmers with the ability to leverage the advantages of VRT methods. Embodiments of the present invention may be used with a diversity of yield monitors including, for example, those manufactured by John Deere, Case IH, Caterpillar, New Holland, Precision Planting, and others. Embodiments of the present invention are not confined to a given brand or type of yield monitor, combine or VRT.

In some embodiments, the present invention may be controlled remotely from a different location using the Yield Link Mobile application. For example, a manager in the agricultural industry, mining industry, shipping industry, banking industry, or any other industry using data capture devices is able to remotely activate and control a device of the present invention, thereby providing the manager with the ability to capture current data on demand, independent of the present invention's location e.g., from the home, the office or other location.

In some embodiments, compositions, methods, and systems of the present invention are configured to be of use in the collection of data from industrial systems configured for use in inspection-type services, for example, monitoring systems used for inspection-type services on industrial equipment including, for example, windmills, vibration monitors, oil temperature monitors, and the like. In further embodiments, inspection-type monitoring data is transferred wirelessly to selected parties for analysis. In particular embodiments, a dashboard of the present invention comprises a cloud center configured to compile data from a particular wind farm, wherein data from a particular windmill is clickable, and the data is transferred from a particular windmill wirelessly to a wind farm manager.

In some embodiments, compositions, methods, and systems of the present invention are configured to be of use in the collection of data from industrial tools for use in inspection-type services including, for example, a mil-thickness tester, used to monitor the mil-thickness of paint or other coating product on a piece of equipment or infrastructure. In certain embodiments, a UAV is equipped with a mil-thickness tester to test the mil-thickness of a coating covering a windmill, bridge, water tower, or the like, wherein the present invention acquires data and transfers data to the cloud. In some embodiments, data is used to forecast due dates for re-coating industrial equipment or infrastructure to protect from potentially hazardous consequences (e.g. rust), and transferred wirelessly to pre-selected parties for analysis.

In some embodiments, compositions, methods, and systems of the present invention are configured for the collection of data from tools used in repair services including, for example, an auto-repair shop, using plug-in computers to collect error codes from vehicles with a check engine light. In particular embodiments, error codes are transferred to the cloud for use by multiple groups as business intelligence. In other embodiments, an error code checker is intermittently or continuously connected to a vehicle. In further embodiments, error codes are compiled for a specific vehicle, wherein all error codes emitted by a vehicle over time are saved on the cloud, and connected to a specific vehicle's VIN number. In still further embodiments, these data are available to potential buyers of the vehicle as an error code history. In yet further embodiments, the present invention is configured to provide a vehicle owner with a history of error codes and problems that have been addressed in the past with a specific vehicle. In other embodiments, a repair shop uses data to detect patterns of error codes shared between vehicles, and circumstances of their occurrence. In some embodiments, the present invention is configured so that vehicle manufactures use the compiled data to detect patterns in repairs and susceptibilities between and across their vehicle lines.

In some embodiments, compositions, methods, and systems of the present invention are used in the collection of data from ground-based wireless sensors. In certain embodiments, data from diverse sensors measuring, for example, soil moisture, irrigation scheduling, insect and disease pressures, frost and temperature alerts, plant growth and the like are collected and transferred using an embodiment of the present invention. For example, a UAV comprising an embodiment of the present invention is configured to wirelessly capture data from ground sensors and stations during a flyover using, for example, a 900 mhz RF signal. After signal capture, the data are transferred to the cloud using, for example, the device's data connection, or by using the Yield Link Mobile app when the UAV returns to its home station or the pilot.

In some embodiments, the compositions, methods and systems of the present invention provide data collection and aggregation coupled to data captured from, for example, a sensor, a monitor, a gps system, a UAV imaging payload, a satellite imaging system, and the like. In certain embodiments, types of data collected and aggregated in embodiments of the present invention comprise pre-season data, in-season data, and post season and harvest data captured by one or more data capture components. In other embodiments of the present invention, data capture monitors provide seeding data, application data (e.g., chemicals, fertilizers, etc.), machine hour and oil temperature data, and the like. In preferred embodiments, compositions, methods and systems of the present invention transmit data from data capture instruments and components to downstream users including, for example, farmers, agronomists, seed dealers, crop consultants, economists, commodities brokers, business partners, vendors and the like, or to the cloud. In contemporary agricultural practice, data capture is stored and aggregated within a computer on board an agricultural implement or a machine monitor for subsequent down-load and analysis. Conversely, compositions, methods and systems of the present invention provide real-time data retrieval, transmission, dissemination and analysis.

In some embodiments, the present invention provides compositions, methods and systems for agriculture data acquisition and analysis that function with diverse sources of data capture monitors (e.g., Precision Planting, Raven, etc.) and systems (e.g., John Deere, Case IH/New Holland, Caterpillar, etc.), thereby freeing the farmer to operate more than a single brand of hardware if, for example, it may be necessary to outsource a particular aspect of the operation to a Co-op or other agricultural retail partner using alternate brand data monitor and capture components. For example, application of fertilizers and chemicals may be outsourced to a third party using different equipment because application requires specific certifications and licenses. If an outsourced Co-op uses spraying equipment that is different from that of the farmer, the farmer cannot easily acquire, collect and aggregate her application data because it is not captured on a shared monitoring platform. Conversely, in particular embodiments of the present invention a farmer may input data from diverse sources and platforms, collect the data, and have it viewable on a cloud platform.

In some embodiments of the present invention, compositions and systems are configured to connect directly to a monitor housed within a machine or implement using wireless data transfer capacity that operates directly with the data capture monitor i.e., rather than using flash cards and data drives to archive data from the monitors. In conventional practice, a user must save data on physical storage media, remove the media from a combine or other implement, connect the physical storage media into a data transferring device, and then transfer the data to its destination. Conversely, in certain embodiments of the present invention, data capture monitors of diverse origins and configurations are directly linked to data aggregation and transfer components without intervening steps or hardware.

In some embodiments, compositions, systems and methods of the present invention provide advantages in the speed, efficiency, cost of data acquisition, transmission, display and analysis. Conversely, conventional agriculture data systems and methods may comprise data transmission fees through intervening parties with attendant costs that are not incurred in specific embodiments of the present invention.

In some embodiments, compositions, systems and methods of the present invention are configured to incorporate data from sensors configured for in-field, real-time data acquisition including, for example, soil temperature, soil moisture, micro-climate data, and the like. Much conventional in-season agriculture data is derived from imagery (e.g., from UAVs or satellites), is physically collected and analyzed data (e.g., from tissue sampling and subsequent laboratory analysis), or from modeling (e.g., from cumulative weather data). These and other data are liable to error, and are limited by temporal relevance. For example, imaging may be skewed by lighting changes or hybrid color variances across a crop. As well, satellite images may have gaps between images of 2 weeks or more. In turn, tissue analysis is constrained by sampling errors, handling errors, shipping errors, delays in analysis, and inconclusive results. Moreover, modeling systems rely on weather and other data based on incomplete data regarding multiple variables including, for example, real-time nutrient data, soil quality data, or disease exposure data. In conventional agriculture practice, data captured from in-field sensors is provided by skipping data from one sensor to the next to a retrieval locus in order to overcome barriers to data transmission encountered in densely planted and rapidly growing row crops at long distances between data sensor and retrieval components. In some embodiments of the present invention, skipping procedures are eliminated using compositions, systems and methods described herein to send data to and from, for example, the cloud or UAV components. In certain embodiments, the location of in-field sensors is marked by UAV ground station software, with data acquired by one or more UAVs comprising compositions and systems of the present invention in wireless communication with the sensors and receivers, and collected by autonomous route fly-overs.

In some embodiments, compositions, systems and methods of the present invention are configured for data acquisition, aggregation, transfer and dissemination of in-field, real-time tissue sampling data including, for example, micro-nutrient data, plant health data, and geographic and field heterogeneity data. In certain embodiments of the present invention, these data are transmitted from the field to the cloud for analysis.

In some embodiments, a wireless data connection is used to capture information from beacon-like sensors which have the ability to broadcast data, the present invention providing a retrieval tool to collect the data. When mounted on a UAV or other robotic tool, this wireless version of the present invention collects this broadcast data, e.g., in difficult regions or environments to access (e.g., vertical collection of soil data through a crop canopy to a UAV mounted version of the present invention is easier than horizontal collection in which the data being broadcast needs to travel over long distances and through more vegetation). Similarly, information being broadcast in any remote or difficult transmission site could be captured by a wireless version of the present invention while mounted on a UAV or robot (e.g., information collected by a lava temperature sensor or a sensor located deep in a mine). In some embodiments, the sensor is in a dangerous location but a wireless embodiment of the present invention mounted to a robot or UAV is able to access the sensor to capture the information and return without putting human lives at stake.

Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the present invention.

### EXPERIMENTAL EXAMPLES

### Example 1

A UAV is housed in a covered box mounted to a pole with a solar panel, weather station, and embodiment of the present invention attached. Each morning, the weather station captures weather data and communicates it to the UAV within the box. Based on wind characteristics, moisture levels, etc., the UAV determines whether today meets good fly day criteria. If so, the UAV communicates with a farmer in Platteville, Wis. by sending an email (i.e., over a Wi-Fi network created by the present invention) notifying the farmer that today is a good day to fly, and that several fields have not been investigated for the past several days. The farmer communicates to the UAV via e-mail or other data transfer that it should fly Fields A, D, and F today, and send the information back to the farmer when it is finished. The UAV is capable of receiving information over the internet using an embodiment of the present invention (i.e., either on-board as a payload, or attached to the UAV station), and communicates with its station and notifies the box to open. When the box opens the UAV ascends and flies its pre-programmed route that has either been saved to the cloud, or has been sent through the cloud by the farmer that day. During the flight the UAV captures NDVI imagery, for example, and when it returns, it lands in the box and begins inductive charging off the energy stored from the solar panel. Simultaneously, it is uploading the imagery it has collected to the cloud (because of the present invention's data transferring application and Wi-Fi connectivity), and sending a notification of data availability to all interested parties. For example, the information collected during that flight is available to the farmer in Platteville, Wis., his cooperative in Hazel Green, Wis., his seed dealer in Dubuque, Iowa and his crop consultant in Illinois.

### Example 2

Shared connectivity enables farmers to control and capture data from their combines in Texas and Oklahoma. While Internet communication may be extremely valuable, it also requires an internet connection. In the middle of a field the farmer may not have this connection. Embodiments of the present invention provide this link.

### Example 3

Using embodiments of the present invention, fully autonomous mining equipment can be run from a computer, tablet, or phone, from the safety of an office. Linking an embodiment of the present invention to the machinery, and plugging it into the machine's data connection not only enables retrieval of valuable equipment information but also provides the ability to control the unit over an internet connection. Accordingly, embodiments of the present invention provide a cloud-enabled “flash drive” capable of use across a wide array of industries for multiple applications. Wi-Fi-connectivity coupled with file transferring embodiments of the present invention provides data capture and output capacities where there is no Internet access otherwise.

### Example 3

A trail/game camera with the capacity to capture images and videos of game in the wild is integrated with embodiments of the present invention to stream images and videos to cloud storage space. E-mail and/or text alerts are added to storage settings to issue alerts to users when a new file is entered cloud storage. Embodiments of the present invention provide data to hunters who hunt far away from their homes, or to outfitters who wish to forward pictures of the trophy game they have on their land to hunters who are flying in during the following week. For example, as a marketing tool customers may be connected to the cloud storage space for a specific camera weeks before they are scheduled to fly out for the hunt. The anticipation to get to the outfitter's land grows as every night the customer receives a text alert of a big buck in front of his stand. Additionally, the hunter stays connected for the months after he leaves the hunt to assure that he returns for the bigger buck he sees on the cloud storage space after he leaves. This marketing tool creates a repeat customer year after year, potentially in the same deer stand, using embodiments of the present invention without the cost and inconvenience of manual data collection and transfer. For hunters living in the Southern part of a state, but hunting hours away in the Northern part of a state, a trail camera set up weeks before deer season and connected to an embodiment of the present invention acquires images sent to the hunter's cloud storage space so he or she may view them as they arrive from his home.

### Example 4

Construction equipment with embodied technology on board to measure hours of uses, depth when drilling, or digging for example, hydraulic information, and the like is linked to an embodiment of the present invention. Data is streamed back to headquarters where a site manager assures efficient and effective use of equipment.

### Example 5

In shipping business systems, data from measured weight on axles, wheel rotations, whether the trailer is loaded correctly (or overloaded to one side) and the like is available but not distributed in real time. Embodiments of the present invention send text or email alerts to drivers if their trailer becomes out of balance after axle weight data has been transferred to the cloud. A controller at headquarters monitors all information as a live-fed to a cloud dashboard in their office from thousands of trucks on the road.

### Example 6

Year to year comparisons of real-time yield maps are provided to wholesale and retail partners in cost-setting and hedging efforts linked to business intelligence tools. Analysts inspecting their company's business intelligence data note that a price change significantly affects their sales volume. They alert their superiors and make the appropriate changes. Because farmers often deal in large sums of money, even seemingly small decisions may have a large impact on their profits. A farmer reviews the trends in his yield data year to year and improves decisions most probable to have driven those trends. For example, a farmer's yields are significantly higher this year, and the only significant difference in decisions from the preceding year is an alternate hybrid for his soil type. The choice could mean the difference of thousands or even tens of thousands of dollars. However, a few bushels/acres worth thousands of dollars may go unnoticed without an embodiment of the present invention with referenced yield data stored on the cloud.

### Example 7

A farming dashboard is individualized to each farm that aggregates all information provided across all farm operations, including yield data from their monitors in the combine, planting data from their planters, spray data from their sprayers, information from their UAV's (e.g., HD imagery, multispectral imagery, yield estimates, soil information, etc.). The dashboard serves as the business intelligence center for the farm, and provides detailed information from past years, current status, and the potential for the future based on extrapolation of variables. Comparing several years' of yield data provides growers the opportunity to identify a trend ahead of competition. Based on this information, a grower chooses to plant a crop that will become scarce at year's end when prices are higher. Conversely, high yields of a given commodity from foreign sources with subsequent downward pressure on prices triggers planting an alternative crop. Year to year comparisons are corrected for the influence of known and quantifiable predictors, for example, rainfall, wind, heat, infestation and the like.

### Example 8

Aggregated, real-time, live-feed data acquired by compositions, methods and systems of the present invention provide data to those trading grain commodities. Yield data from national and international sources is downloaded to a home server, and integrated into a dashboard platform for use by the grain and other commodity traders. Upon opening the trading platform, users are provided live-feed data as it is acquired at, for example, the combine, thereby enabling better trades with the most current information. Information aggregated across specific geographic locations gives traders improved estimates of crop performance as the information is acquired and retrieved.

### Example 9

A website/dashboard provided to the farmer and commodity trader provides substantial advertising revenue. The dashboard is provided as a subscription service to farmers and growers interested in new equipment, technology, building materials and methods, transportation, agricultural implements, and the like. The dashboard is provided as a subscription service to commodity traders interested in life-style and luxury products.

### Example 10

Agricultural service providers use data from the compositions, methods and systems of the present invention to evaluate relative product success or failure on a specific field, and to determine product success across a customer-base. Live-feed yield information provides agricultural service providers with a dashboard to refine and improve and customize year to year recommendations. Early identification of an inferior or superior product within a given customer-base supports advanced product information for the succeeding year with improved yields.

### Example 11

A yield map generated by compositions, methods and systems of an embodiment of the present invention is used to determine the amount of macro and micro nutrients extracted from the soil in a given year based on our yield amount in specific regions of a field (i.e., 200 bushels/acre corn is extracts double the nutrients of 100 bushels/acre corn). Based on this information the amount necessary to apply to replenish vital nutrients for specific regions of a field is determined.

### Example 12

Using a given seed hybrid strain, compositions, methods and systems of an embodiment of the present invention reveal a 20 bushels/acre decrement in regions of a field with sandy soils. The following year, a drought resistant, sandy soil tolerant type seed is planted in that area of the field. Using a geo-referenced yield map provided by the present invention, the grower learns where to plant the new hybrid next year using VRT methods for field planting.

We claim:

1. An agriculture data acquisition system, comprising:
a) at least one agricultural monitor in electronic communication with an agriculture data acquisition device;
b) an agriculture data acquisition device comprising:
1) a universal series bus (USB);
2) a USB compatible cable;
3) a power adapter and AC/DC converter;
4) a tablet computing device or a micro-computer device comprising a processor
5) a microcomputer unit operating system;
6) agriculture data acquisition software on computer readable media configured for auto-booting of said device, file recognition, retrieval and transfer to a cloud-based storage facility and access by credentialed users; and
7) an enclosure; and
c) a dashboard visual display for display of agricultural, service provider, or economic data acquired by said agriculture data acquisition system.

2. The agriculture data acquisition system of claim 1, wherein said tablet computing device or said microcomputer device further comprises a micro SD card and 4G connector.

3. The agriculture data acquisition system of claim 1, further comprising at least one data transfer component selected from Wi-Fi, Bluetooth, cell phone data connection, or other wireless data connectivity component.

4. The agriculture data acquisition system of claim 1, wherein said system is configured to collect preseason data, in-season data, and/or post-season data.

5. The agriculture data acquisition system of claim 1, wherein said system is configured to collect:
(a) preseason data selected from: macro- and/or micro-nutrient data relating to nutrient replacement needs in the soil; imagery data relating to various light spectra selected from infrared, thermal infrared, visible, and other spectra; soil data selected from soil moisture, soil temperature, pH level, nutrient levels, biological levels, biomass levels, fungus levels, and other soil data; climate data; micro-climate data; heat unit measurements; moisture measurements; micro-temperature measurements; sunlight levels; compaction measurements; and other preseason data;
(b) in-season data selected from: macro and/or micro-nutrient data relating to the plant and its overall nutritional status; imagery data relating to various light spectra selected from infrared, thermal infrared, visible, and other spectra; soil data selected from soil moisture, soil temperature, pH level, nutrient levels, biological levels, biomass levels, fungus levels, and other soil data; plant-specific information selected from nutrient uptake, current nutrient levels, various health readings relating to sugar levels, bacteria levels, fungus levels, and/or other plant-specific information; climate data; micro-climate data; heat unit measurements; moisture measurements; micro-temperature measurements; sunlight levels; photosynthesis measurements; chlorophyll measurements; and other in-season data; and/or
(c) post-season data selected from: yield data; harvest data; macro- and/or micro-nutrient data; nutrient replacement needs in the soil; imagery data relating to various light spectra selected from infrared, thermal infrared, visible, and other spectra; soil data selected from soil moisture, soil temperature, pH level, nutrient levels, biological levels, biomass levels, fungus levels, and other soil data; climate data; micro-climate data; heat unit measurements; moisture measurements; micro-temperature measurements; sunlight levels; and/or other post-season data.

6. The agriculture data acquisition system of claim 3, wherein the dashboard visual display is accessible by a user, via the data transfer component, wherein the user is a farmer, mine manager, equipment operator, business manager, analyst, business advisor, crop consultant, agronomists, seed dealer, or other end user.

7. A method for acquiring agricultural data, comprising:
a) providing an agriculture data system, comprising
1) at least one monitor in electronic communication with an agriculture data acquisition device;
2) an agriculture data acquisition device comprising:
a) a universal series bus (USB);
b) a USB compatible cable;
c) a power adapter and AC/DC converter;
d) a tablet computing device or a micro-computer device comprising a processor
e) a microcomputer unit operating system;
f) agriculture data acquisition software on computer readable media configured for auto-booting of said device, file recognition, retrieval and transfer to a cloud-based storage facility and access by credentialed users; and
g) an enclosure; and
3) a dashboard visual display for display of agricultural, service provider, or economic data acquired by said agriculture data acquisition system; and
b) inputting data from said at least one monitor;
c) transfer said data to said cloud-based storage facility; and
d) displaying said data on said dashboard.

8. The method of claim 7, wherein said data is transferred wirelessly via a Wi-Fi, Bluetooth, cell phone data connection, or other wireless data connectivity component.

9. The method of claim 7, wherein said data is used to generate prescription maps, planting maps, or other maps for VRT applications, bio-stimulant applications or other applications, based on soil, plant, biological, weather, micro-climate, or other agricultural data.

10. An agriculture data acquisition device comprising:
a) a universal series bus (USB);
b) a USB compatible cable;
c) a power adapter and AC/DC converter;
d) a tablet computing device or a micro-computer device comprising a processor;
e) a microcomputer unit operating system;
f) agriculture data acquisition software on computer readable media configured for auto-booting of said device, file recognition, retrieval and transfer to a cloud-based storage facility and access by credentialed users; and
g) an enclosure.

11. The harvest data acquisition device of claim 10, wherein said tablet computing device or said microcomputer device further comprises a micro SD card and 4G connector.

12. The harvest data acquisition system of claim 10, further comprising at least one component Wi-Fi connectivity component.
